(19) United States
(12) Patent Application Publication
(10) Pub. No.: US 2014/0059089 A1
(43) Pub. Date: Feb. 27, 2014

(54) METHOD AND APPARATUS FOR STRUCTURING A NETWORK

(71) Applicant: John Alexander Bryden, Egham (GB)

(72) Inventor: John Alexander Bryden, Egham (GB)

(73) Assignee: ROYAL HOLLOWAY AND BEDFORD NEW COLLEGE, Surrey (GB)

(21) Appl. No.: 13/994,735

(22) PCT Filed: Dec. 16, 2011
(86) PCT No.: PCT/GB2011/001735

§ 371 Date: Nov. 13, 2013

(30) Foreign Application Priority Data
Dec. 17, 2010 (GB) 1021446.8

(51) Int. Cl. G06F 17/30

(52) U.S. Cl. CPC G06F 17/30289
USPC 707/803

(57) ABSTRACT

There is provided a method of structuring a network of nodes, comprising: providing link information relating to existing links between the nodes (2); using the link information to partition the network into non-predetermined groups of related nodes (3), thereby forming a group structure for the network; identifying for each group a corpus of information associated with the nodes in that group (4); generating for each group a machine-readable characterisation of that group based on the corpus of information identified for the group (5); and structuring the network of nodes through the groups and their associated characterisations (2 to 7).

### TECHNICAL FIELD

The present invention relates to a method and apparatus for structuring a network.

### BACKGROUND

Interconnected computer servers may contain large amounts of information in various formats. This can be broken up into units which can be referred to as information items. An information item could represent information in any form (including textual, auditory, or visual), or be a piece of information that represents a physical entity (including a human user) outside the information contained on the computer servers.

Many examples exist in which this information contains data that can be interpreted as links between the containing information and other information on the same computer server or on other computer servers. This means that a representative network can be formed of the information contained on such a system or some part of the data or information contained on such a system. Since information items can themselves represent physical entities, such a network could represent a physical system.

An example of such a network could be formed by nodes that represent physical computer servers. The links of the network could represent physical and/or logical links between the computer servers.

Another example of such a network could be formed by nodes that represent individual data files held on the computer servers. The links of the network could represent references, held within the data files, to other data files.

When the networks formed from this linked information are relatively unstructured or homogeneous in form, the present applicant has appreciated that there can be value in forming and characterising meaningful groups of nodes. This then implies that the underlying entities (for example, computer servers or data files) referred to by those nodes can be considered to be formed into meaningful groups.

One benefit in doing this is that changes can then be made to the underlying computer servers and their interconnections according to which group (and the characterisations of the group) they are placed in. In another example, there is benefit in making changes to information represented by the network nodes according to which group (and the characterisations of the group) they are placed in. A further benefit is that new information unrepresented by the nodes may be assimilated (perhaps by adding links) so that it can then become represented by the network. A further benefit is that any processes performed on items represented by network nodes can be optimised by being carried out according to which group (and the characterisations of the group) they are placed in.

Where the information is largely textual, previous approaches (for example: Anton Leuski. 2001. Evaluating document clustering for interactive information retrieval. In Proceedings of the tenth international conference on Information and knowledge management (CIKM '01)) have shown that it is possible to form meaningful groups by looking for clusters of text usage in the documents. However, such techniques do not take advantage of the information about the relatedness of information items that is available from an analysis of the topology of links between documents.

It has separately been proposed that the use of links between information items can provide evidence of how the information is related, for example He, Xiaofeng, Zha, Hongyuan, Ding, Chris H. Q., & Simon, Horst D. (2001). “Web document clustering using hyperlink structures”. Lawrence Berkeley National Laboratory.

However, it has been appreciated by the current applicant that additional processing is required to make the identified clusters sufficiently useful in further information processing tasks such as information retrieval and document classification.

Such tasks are known to be of high importance and to be increasingly difficult to carry out effectively as information volumes are rapidly increasing.

Additionally, where the information items are not textual in nature, but where links between them are explicit and/or can be inferred, it has been appreciated that there is also benefit in forming meaningful groups. For example, if the nodes and links correspond to a network of computer servers and links between them, the identification of meaningful groups can be of value in network management and optimisation.

One example where the information items are largely textual is the World Wide Web, in which information is generally contained in web pages that typically contain HTML hyperlinks to other web pages.

Web pages are stored on web servers, which are required to respond to incoming requests for information. The information stored on a particular web server is in itself an information network. Organising the storage and processing devices that implement a web server to enable it to be sufficiently responsive to incoming requests is a difficult problem (for example Samee Ullah Khan, Ishfaq Ahmad, Comparison and analysis of ten static heuristics-based Internet data replication techniques, Journal of Parallel and Distributed Computing, Volume 68, Issue 2, February 2008).

Many information access systems provide a user of one information item with automatically-generated navigation tools enabling access to related information items. For example a product web page might provide a list of links to related products to the one being viewed. These suggested information items may contain links to related products, information, or media items that are similar or relevant to those currently being accessed. Finding the right items to place in the navigation list is a difficult problem but in many contexts, for example large retail websites such as Amazon, the quality of such navigation tools is important to the function of the system.

Another such example might be a social network, for example Facebook. In such networks, information resides in many forms. This potentially includes pages owned by the social network users, messages posted on those pages by the owning user or by other users, messages exchanged between users, and information relating to the allowed forms of communication between users, for example a user's “Friends” list. Several of these types of information can be seen as forming links between users of the social network, including but not restricted to Friends lists and the frequency with which particular users exchange messages or post comments on each others' pages.

A further example might be one or more blogs, microblog systems or web pages that allow users to add comments on a main topic and/or on comments previously added by themselves or by others. Examples of the latter include media-related websites such as the Internet Movie Database or YouTube, retail websites such as Amazon that invite users to review products or journalistic websites such as those owned by newspapers or broadcasting organisations.

Such blog or microblog entries or user-generated comments often contain explicit or implicit references to other information sources, including but not limited to web pages, blog entries, other user-generated comments, and/or to names identifying users of email or social media.

In all of these examples there are complex information networks embodied on computer networks that are linked either deliberately by the human authors or automatically.

Examples of linking performed by humans could be hyperlinks inserted by a web page author, voluntary membership of groups in social networks or references to other social media users or topics mentioned in a microblog entry.

Examples of linking performed by automatic processes could be links formed from data passed between services running on a network of (one or many) computer servers, lists of URLs generated by an automatic web search engine or web feed engine such as RSS, or social media users paired according to heuristics based on their demographics and other characteristics. Further to this, some nodes may be linked (or have their link strength increased) when the same user records some machine-readable activity (such as accessing a web page, for example) for both nodes within a specified time-period or number of interactions with the system or the user accesses one node from another.

Automatically identifying information from such complex networks that is most appropriate in a particular context is known to be a challenging problem. It is important not only in locating relevant information for particular information processing tasks, a well-established field known as information retrieval, but increasingly in determining how to insert new information into existing information structures such as document stores, social networks or the World Wide Web.

The present applicant has appreciated the desirability of addressing these issues.

### SUMMARY

According to a first aspect of the present invention there is provided a method of structuring a network of nodes, comprising: providing link information relating to existing links between the nodes; using the link information to partition the network into non-predetermined groups of related nodes, thereby forming a group structure for the network; identifying for each group a corpus of information associated with the nodes in that group; generating for each group a machine-readable characterisation of that group based on the corpus of information identified for the group; and structuring the network of nodes through the groups and their associated characterisations.

The partitioning step may comprise assigning each node to at least one group of nodes where groups are defined by their topological characteristics, relating to the number and/or weights of the links within the group with respect to the rest of the network.

Where the links are weighted, the partitioning step may comprise assigning each node to at least one group of nodes so as to approach a maximum proportion of the combined weights of links that are between nodes of the same group, when compared with the proportion of links that are between nodes of the same group when all links are randomly rewired.

The partitioning step may follow or use the techniques described in Blondel et al., “Fast unfolding of communities in large networks”. J. Stat. Mech. Theory Exp. 10, P 10008, 2008.

The partitioning step may comprise assigning each node to at least one group of nodes so as to tend to maximise the number of links that are between nodes of the same group. Where the links are weighted, the partitioning step may comprise assigning each node to at least one group of nodes so as to tend to maximise the weight of the links that are between nodes of the same group.

Where the links are weighted, the partitioning step may comprise assigning each node to at least one group of nodes such that the sum of the weights of links within groups tends to be greater than the sum of the weights of links between groups, where a node can be allocated to any number of groups.

The partitioning step may comprise assigning each node to at least one group of nodes by removing edges with the greatest edge-betweenness.

The structuring step may comprise enabling the group structure to be examined through the generated characterisations to allow new links into the network to be created or inferred, and/or to allow existing links to be updated.

The structuring step may comprise examining the group structure of the network using the characterisations to create or infer new links into the network, and/or to update existing links.

The structuring step may comprise receiving or providing a further node not already placed within the network, using information associated with the further node to examine the group structure of the network through the characterisations, classifying the further node as a result into at least one existing group, and at least inferring at least one link between the further node and at least one of the nodes in the at least one group.

The method may comprise incorporating the further node into the network within the at least one group.

The method may comprise creating at least one link between the further node and an existing node in the network and/or incorporating or merging the further node into at least one existing node in the network.

The method may comprise providing information relating to at least one of the nodes linked to the further node through the at least one inferred link.

The further node may be or may comprise or represent a search term, and the information provided may represent the result of a search query.

The method may comprise performing further searching within information relating to at least one of the nodes linked through the at least one inferred link.

The structuring step may comprise creating new links associated with an existing node based on its position within the group structure

The structuring step may comprise storing or providing information relating to the groups and/or their associated characterisations.

The structuring step may comprise physically arranging or re-arranging the nodes of the network based on the determined group structure.

The method may comprise selecting at least one of the storage location, storage device and access technique for a data or information item associated with a node in dependence upon the group or groups into which that node has been partitioned.

The partitioning step may comprise assigning each node to at least one group of nodes.

At least one group of nodes may comprise within it at least one other group of nodes.

The characterisation may comprise a signature, the signature for a group being generated based on the corpus of information for that group.

The characterisation may comprise at least one label, the label for a group being generated based on a comparison between the corpus of information for that group, or information derived therefrom, and the corpus of information for at least one other group, or information derived therefrom.

The link information may comprise a weighting for each of at least some of the links, the weighting being for example an indication of the degree of similarity between linked nodes.

At least one of the nodes may be or may comprise a computer server.

At least one of the nodes may be or may comprise a data item. At least one of the nodes may be or may comprise an information item.

At least one data item may comprise a document, a machine-readable file such as a data file or an executable file, or a plurality of machine-readable characters such as a search term.

At least some of the nodes may comprise a web page and/or blog, or element thereof such as an article or blog posting.

At least one of the nodes may represent an individual.

At least one of the nodes may represent a service run on or provided by a computer server.

The method may comprise selecting the computer server to run a service in dependence upon the group or groups into which the service has been partitioned.

A link between two nodes may be an indication of some degree of similarity between the two nodes, actual or perceived, with the degree of similarity having been assessed manually or automatically.

A link between two nodes may be an indication of a relationship or connection or interaction or transaction or correlated behaviour between the two nodes, past, present or future.

At least one link between two nodes may be a logical link between the two nodes.

At least one link may be derived or inferred from information relating to the two nodes.

The providing step may comprise deriving or inferring at least one link.

At least one link between two nodes may be or may represent a physical connection between the two nodes.

At least one link between two nodes may be in the form of a hyperlink such as a URL.

The method may comprise, for at least one of the nodes, including metadata associated with that node information in the corpus of information for that node.

The method may comprise, for at least one of the nodes, including information from sources external to that node in the corpus of information for that node.

The network of nodes may represent an information network.

The information network may be embodied on or as or within a computer network.

The partitioning carried out in the partitioning step may be based entirely on links between the nodes, or substantially on links between the nodes.

At least one node may be assigned to more than one group of nodes.

The machine-readable characterisation for at least one group may be the corpus of information for the group.

The method may be a computer-implemented method, or it may be implemented in hardware.

According to a second aspect of the present invention there is provided an apparatus for structuring a network of nodes, comprising: means for providing (or a processor arranged to provide) link information relating to existing links between the nodes; means for using (or a processor arranged to use) the link information to partition the network into non-predetermined groups of related nodes, thereby forming a group structure for the network; means for identifying (or a processor arranged to identify) for each group a corpus of information associated with the nodes in that group; means for generating (or a processor arranged to generate) for each group a machine-readable characterisation of that group based on the corpus of information identified for the group; and means for structuring (or a processor arranged to structure) the network of nodes through the groups and their associated characterisations.

Referring to a method according to the first aspect of the present invention, the step of structuring a network can be understood as meaning giving structure to a network, determining the structure of a network or revealing structure within a network. This is the case when a network without any apparent order is analysed to reveal some order or structure, thereby structuring (or giving structure to) the network. Further steps can then be taken to make use of the structure, or to perform further specific structuring steps. It is to be understood that, in a method according to the first aspect of the present invention, the steps of providing, partitioning, identifying and generating can themselves collectively be considered to be the step of structuring the network, without a further explicit structuring step being required. Likewise, in the apparatus according to the second aspect of the present invention, the means for providing, partitioning, identifying and generating can be considered collectively to be the means for structuring the network.

There is also provided a program for controlling an apparatus to perform a method as set out above or which, when loaded into an apparatus, causes the apparatus to become an apparatus as set out above. The program may be carried on a carrier medium. The carrier medium may be a storage medium. The carrier medium may be a transmission medium.

There is provided an apparatus programmed by such a program.

There is provided a storage medium containing such a program.

As mentioned above, automatically identifying information from such complex networks that is most appropriate in a particular context is known to be a challenging problem. An embodiment of the present invention provides a method and apparatus for automatically identifying such appropriate information and automatically modifying, moving or copying it, or using its contents to automatically modify, move or copy information held elsewhere.

An embodiment of the present invention can be considered to relate generally to data processing and more particularly in some implementations to the automated moving of information between computer servers, based on the comparison of an analysis of the content of that information with an analysis of the content of information residing on, or having previously been transferred between, those servers and other computer servers.

An embodiment of this invention involves the automatic identification of meaningful groups of related nodes within complex information networks, automatic generation of machine-readable characterisations of these groups based on their distinguishing properties and use of these characterisations to automatically transfer information between computer servers based on matching those characterisations against other information.

This could take the form of automatically transferring information from or about the groups to other computer servers based on the characterisations of the groups.

One of many examples of such an application might be to move, copy and organise data so as to optimise data access based on anticipated usage patterns for the identified groups of related nodes.

Another family of applications will identify groups of documents or media items and copy information from them to another location for further processing. The types of document could include related blogs or online discussion groups that frequently contain discussions about a particular topic, videos, audio files, text documents or web pages.

An alternative family of applications involve new information that is not necessarily in the same format as the original complex information network. The new information is matched to the groups of related nodes, based on the characterisations of the groups. If the new information is in a similar format to the original, it can then be automatically transferred into the information sub-networks identified by the matching groups. The new information can also be used to update or complement the machine-readable categorisations of the groups in order to enhance future context-specific processing.

One of many examples of such an application might be to automatically process a potential blog entry and, based on comparing its characteristics with those identified for groups of information including other blog entries, automatically transfer the information in the blog entry to an appropriate computer server and modify information held on that or on another computer server so as to incorporate the information as an entry into one or more blogs containing similar information.

A distinctive contribution of an embodiment of the present invention is the formation of meaningful groups of information items using a two-step process. First, groups are identified of information items using known topological analysis techniques on the network of explicit or implied links between the nodes, but without initially inspecting the nature of the information being linked. Second, a further step characterises each group based on a comparison of the information contained within the group or associated with it and the information contained within or associated with the other identified groups.

The characterisation information generated for the related groups thus allows processing to be done within contexts identified by the nature of the information generated. This new information can subsequently be used as described above.

Techniques for identifying groups of nodes based on the links between them have previously been disclosed (for example Fang Wei, Weining Qian, Chen Wang, and Aoying Zhou. 2009. Detecting Overlapping Community Structures in Networks. World Wide Web 12, 2 (June 2009), 235-261). Separately, techniques for comparing and grouping bodies of information based on the information contained within them or associated with them have been previously disclosed (for example Fabrizio Sebastiani, Machine Learning in Automated Text Categorization, ACM Computing Surveys, Vol. 34, No. 1, pp. 1-47, 2002).

However, an embodiment of the present invention combines both an initial identification of closely-linked groups and a subsequent characterisation of those groups based on their comparative information content.

This automatic characterisation of derived meaningful groups can be used to automate significant information processing tasks. In many kinds of information networks, including the specific examples that we describe, the combination of these analysis techniques with the subsequent information processing techniques that we describe leads to qualitative improvements in the outputs from that information processing.

In preferred embodiments of the invention, the characterisations of the related groups may be separated into a part that is human as well as machine-readable and a part that is purely machine-readable.

### BRIEF DESCRIPTION OF THE DRAWINGS

FIG. 1 is an overview diagram illustrating a method and apparatus according to an embodiment of the present invention, showing an example flow of information processed.

FIG. 2 illustrates a type of information network that might be processed and is used to describe brief illustrative examples.

FIG. 3 illustrates the step of grouping the nodes of such a network based on their interconnections so as to identify nodes that are closely associated.

FIG. 4 illustrates the step of amalgamating data from the grouped nodes to provide for each a corpus that can be used to characterise each group by comparison with the other groups.

FIG. 5 illustrates the analysis and labelling of the groups based on a comparison of the corpora.

FIG. 6 illustrates a form of subsequent data processing involving classifying new information by comparison with the labels and/or signatures created in FIG. 5 and/or the corpora of the group and inserting the information into the groups or associating it with them.

FIG. 7 illustrates an alternative or additional form of subsequent data processing involving a similar comparison of new information as described in FIG. 6, but annotating the labels and/or signatures and/or corpora of the groups based on this comparison.

FIG. 8 is a schematic illustration of a computer apparatus in which a method embodying the present invention may be implemented.

FIG. 9 summarises the nature of the invention, how it and applications based upon it relate to real world objects, and how information is processed by the invention and by such dependent applications.

### DETAILED DESCRIPTION

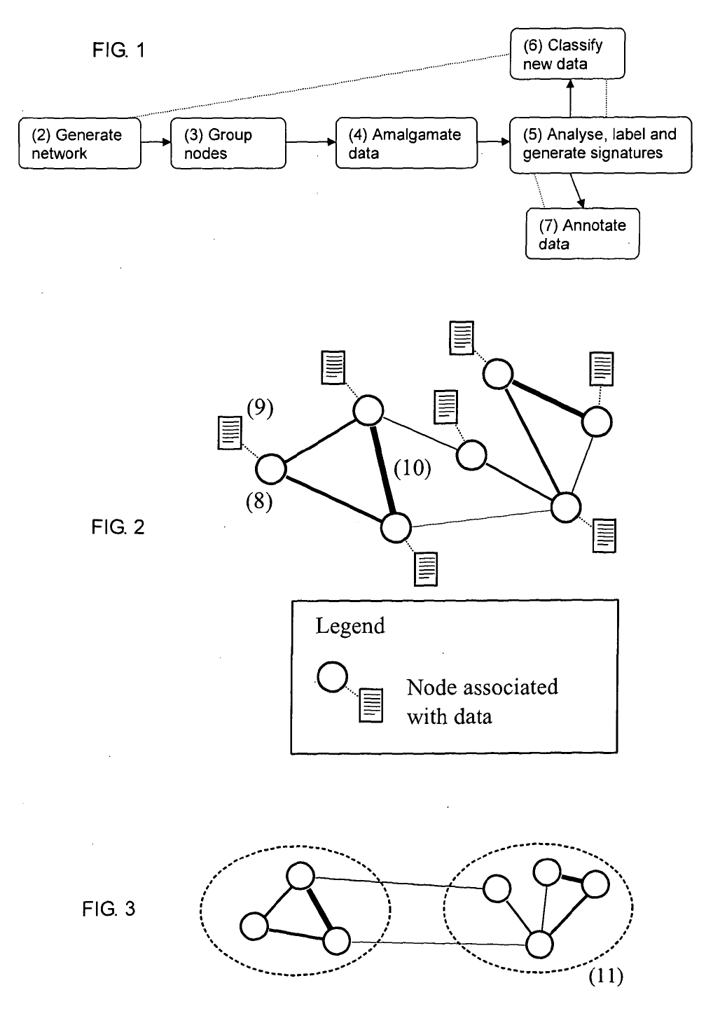

FIG. 1 provides a schematic overview of a system and method embodying the present invention. Arrows show the steps the process will take. Dashed lines show how the different processes may update data at each stage.

Referring to FIG. 1, a network is generated with nodes representing information (or data) items of the data the system is processing and links are inferred between the nodes (2). This step can be considered as being one of providing link information relating to existing links between the nodes. An existing link between two nodes can be considered to be an indication of some degree of similarity between the two nodes, actual or perceived, with the degree of similarity having been assessed manually or automatically. A link may be a logical link and/or inferred from information relating to the linked nodes. A link between two nodes can be considered to be an indication of a relationship or connection or interaction or transaction or correlated behaviour between the two nodes, past or present.

The network is processed into groups of nodes (3). This step can be considered as involving the use of the link information to partition the network into non-predetermined groups of related nodes, thereby forming a group structure for the network.

Data of the nodes of each group are amalgamated into corpora (4). This step can be considered as identifying, for each group, a corpus of information associated with the nodes in that group.

Labels and machine-readable signatures are generated for each corpus in the context of the other groups (5). This step can be considered as generating, for each group, a machine-readable characterisation of that group based on the corpus of information identified for the group.

The network of nodes is structured through the groups and their associated characterisations. In this sense, structuring a network can be understood as meaning giving structure to a network, determining the structure of a network or revealing structure within a network. This is the case when a network without any apparent order is analysed to reveal some order or structure, thereby structuring (or giving structure to) the network. Further steps can then be taken to make use of the structure, or to perform further specific structuring steps. For example, the machine-readable signatures can be used to match groups to new data. This allows for classification of new nodes (6), and/or groups may be annotated (7) by external information that is linked to data that can be compared to a machine-readable label and/or signature.

The same process may be performed many times with different types of links. For example, in embodiments that analyse online social networks, one type of link could be formed based on conversations between users. Another type of link could be formed based on whether the two users had been marked as friends within the online social network. These link types can then form metadata for any group characterisation data generated by each iteration of the process. Alternatively, several types of links, with appropriate relative weightings, could be combined into the same network and then structured. In general, for any particular set of nodes there may be several methods for forming links to form different networks, some of which might contain corresponding links as well as corresponding nodes. Structuring the different networks will reveal different structure, reflecting different kinds of relationships between the underlying nodes.

In each case, the ultimate result might be automatically to move, copy or modify information held on a computer network by changing the state of the permanent storage devices associated with that network as a result of one or more of the mechanisms described above.

FIG. 2 is provided for use in describing step (2) of FIG. 1 (generate network) in more detail.

The figure shows a network where each node (8) has some data (9), and often metadata, associated with it. The nodes are linked together (10) with unidirectional or bidirectional links of different weights. In many embodiments of the invention, at least some of the data and/or metadata will represent human-generated text.

Nodes might, for example, represent executable and information files on one or more servers with links including the invocation of executable files by other files or the reading of information files by the executable files. Such links could be derived by automatically reading the files to identify static invocations or file access, or by monitoring a system in operation over time to build a historical record of actual accesses by one file of another.

In another example, nodes could represent services run on computer servers on a network. Data associated with the nodes could be samples of the data transmitted by the services, resource usage patterns of the services, text describing the services, or the metadata tags used by the services. Links could then represent data flowing over the network between the servers, with links weighted by the volume of data transferred per unit of time. In a different embodiment, links could represent the correlation (calculated using a statistical method, for example Pearson's correlation coefficient) of patterns of resources usage by services, with links weighted according to the strength of correlation.

In another example, nodes might be computer files containing textual content where finks between the files have been manually or automatically-generated with the intention of identifying files with similar content, or between which a human reader may wish to navigate. Examples of this kind of network include pages on the World Wide Web, held on a single web server or distributed across servers, or documents within a document, content or record management system.

In another example, a node might represent a web page or a document accessed from a document classification system. Links between nodes could be generated from the access history of the nodes. For example, when a user accesses two nodes within some specified time-period or number of interactions with the system, the link between them is strengthened. In a another example, when the information items represented by nodes contain hyperlinks and a user follows a hyperlink, the link may also be strengthened between the two nodes. The link might also be strengthened if the user navigates from one information item to the other via one or more intervening hyperlinks and web pages. In such cases, an embodiment would be likely to decrease the degree of strengthening of the link depending on the number of intervening links and/or pages. Other factors related to the browsing session might also be taken into account in determining the link strength, for example the length of time the user spends on a page, which might indicate its level of interest, and whether a page was the last visited, or the last visited before a check-out page, which might indicate that the user had found what they wanted to view or purchase.

In another example, a node might represent a user of an online social network such as Twitter. A link could then represent, for example, interactions between users on the social network. Links between the nodes can be of different weights, so in this example the weight of a link could represent the number of messages sent between users. The data associated with the node can be in any format—in this example it would be likely to include the word text of messages sent and/or received by each user to or from other users. Additional links might include the other users that a user is following, or users' Friends lists. In different embodiments of the invention, these types of links might be given different weights in determining the overall weight of the link between two users. Alternatively, or in addition, the different link types might be used to form different networks, whose group structures would reveal different types of relationship between users.

In another example, nodes might represent an individual that makes financial transactions such as a bank account holder or a company/corporation. Data associated with the nodes could include any information about the individuals, examples being geographical location, type of business, names, dates etc. In some embodiments, links could then represent financial transactions between two individuals and could be weighted by intensity of the transactions, for example the amount of money transferred per unit of time. Other embodiments could have links representing the correlation (calculated using a statistical method, for example Pearson's correlation coefficient) of a financial metric, for example stock price, between two individuals with links weighted by the strength of correlation.

In some embodiments of the invention, the data associated with the nodes may influence the weighting of the links. Links between nodes that share particular characteristics, for example, might be more heavily weighted.

The data associated with each node may include both metadata and data that physically resides in other data storage locations or databases. For example, if a node represents a document, the data associated with the node may include the technical qualifications of the author of the document, which may reside in a staff database that is physically separate from the document but contains information about the document's author. The latter is recorded in the document's own metadata, while the former could be retrieved from the database and included in the node's associated data.

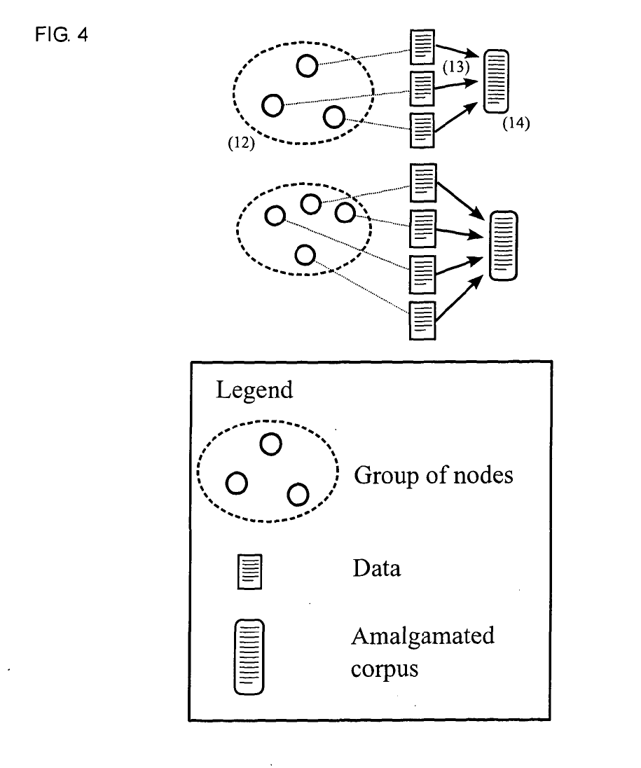

In some embodiments of the invention, such incorporation of external data may be implemented at the data amalgamation stage described in FIG. 4, for reasons of performance or simplicity of implementation.

FIG. 3 is provided for use in describing step (3) of FIG. 1 (group nodes) in more detail.

The figure shows the nodes assigned into groups (11). In some embodiments of this invention, one node may be a member of more than one group. Groups are defined by their topological characteristics with respect to the remainder of the network. They are defined based on the links between the nodes and their weights, rather than on the data associated with the nodes.

For example, nodes may be assigned to groups so that the number of links (or the weight of the links) that are between nodes of the same group is maximised (for example, see Blondel et al., “Fast unfolding of communities in large networks”. J. Stat. Mech. Theory Exp. 10, P 10008, 2008).

Other methods may be user to assign nodes to groups, for example several methods are described in Community detection in graphs (Santo Fortunato Phys. Rep. 486, 75-174, 2010). These algorithms are all characterised by the allocation of nodes of a network into groups so that the links tend to be within, rather than between, groups. A node can be allocated to any number of groups. Where links are weighted, the allocation of nodes of a network into groups so that the sum of the weights of links within groups tends to be greater than the sum of the weights of links between groups.

Another candidate algorithm generates communities by removing edges with the greatest edge-betweenness (Girvan M. and Newman M. E. J., Community structure in social and biological networks, Proc. Natl. Acad. Sci. USA 99, 7821-7826 2002). A second class of algorithms look for the partition with the maximum modularity. The modularity of a partition is given by: the proportion of links that link nodes within the same group less the expected proportion of links that would link nodes within the same group after all links are randomly rewired. An example of this is Blondel et al, referenced above. A third class of algorithms find overlapping partitions (where a node can belong to more than one group) by looking for local communities. These include clique percolation (Uncovering the overlapping community structure of complex networks in nature and society G. Pella, I. Derényi, I. Farkas, and T. Vicsek: Nature 435, 814-818 2005) and local expansion (Detecting Overlapping Community Structures in Networks with Global Partition and Local Expansion, Fang Wei, Chen Wang, Li Ma and Aoying Zhou, Lecture Notes in Computer Science, 2008, Volume 4976/2008, 43-55).

In all embodiments, links between nodes imply that the nodes are similar in some way. The grouping algorithm thus forms groups of similar nodes.

In embodiments where some of the nodes represent executable files and some of the links represent invocation of other executable files or access to information files, similar groups identified may correspond to particular software applications.

In examples where the nodes represent text files of some kind, the similar groups identified represent files between whose members a large number of human and/or machine-generated links have been created. These links exist because human authors, document librarians or automated document indexing or classification mechanisms have created them based on similarities between documents.

The grouping algorithm identifies groupings based on all the links in the network that are used in a particular embodiment of the invention. This is likely to identify groupings of information that were not apparent to any previous human author, librarian or automated document organisation mechanism.

In social network examples, the similar groups identified are likely to have been formed by the principle of homophily (for example see M. McPherson, L. Smith-Lovin, and J. M. Cook, “Birds of a Feather: Homophily in Social Networks,” Annual Review of Sociology 27. 2001).

In some embodiments, the groups may be placed in a hierarchy (i.e., with groups within groups).

FIG. 4 is provided for use in describing step (4) of FIG. 1 (amalgamate data) in more detail.

The figure shows how the data associated with the nodes of each group identified in the previous figure (12) is amalgamated (13) into a corpus (14).

These corpora act as repositories of any relevant data (or references to data) associated with the nodes within the groups.

Where some of the node correspond to executable files, for example, the data is likely to include file header and metadata information. This is likely to include information indicating which computer applications particular executable files are associated with: for example Microsoft® Office® or Google® Android®.

For the example of the social network, in one embodiment the collections of messages of each user would be combined together, along with any additional information that had been incorporated in the data.

In some embodiments, the data may not include any textual information at all. For example the nodes might represent entities that are taking part in financial transactions. In this case, the data would be likely to include information including the type, magnitude and time of the transactions, but might not include any explanatory textual information.

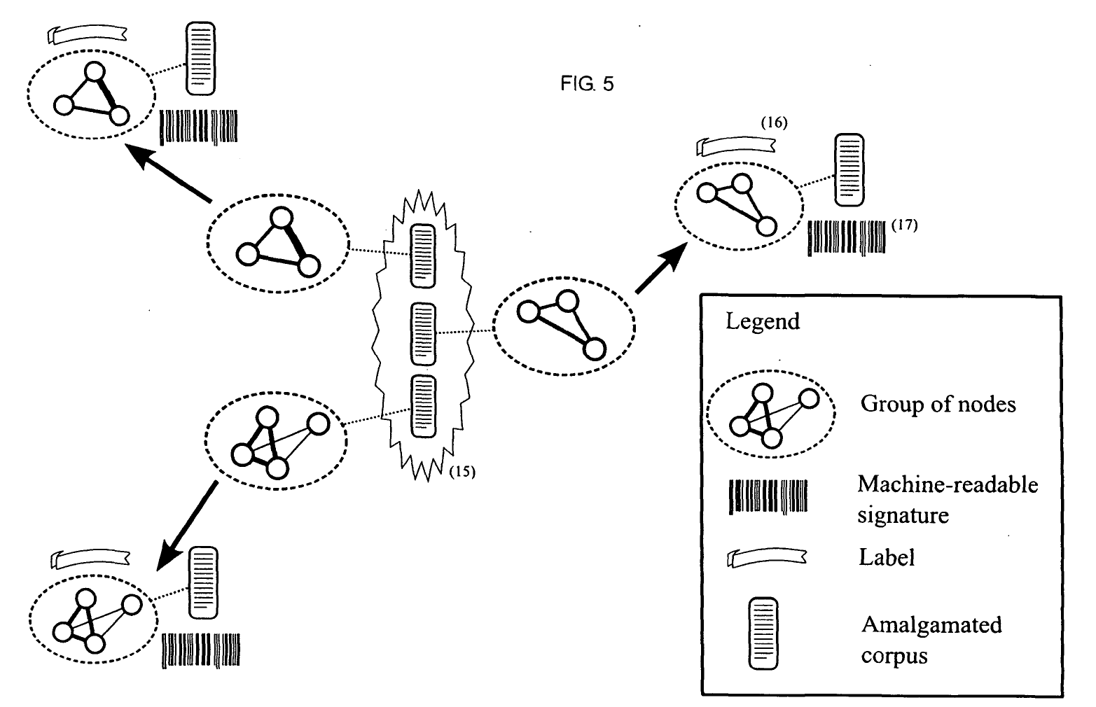

FIG. 5 is provided for use in describing step (5) of FIG. 1 (analyse, label and generate signatures) in more detail.

Automatic analysis is performed on the data corpora for each group in context of the corpora of the other groups (15). In many embodiments, the primary input into this corpus analysis is the text contained in the amalgamated data generated for each group in the previous diagram. The analysis may also, however, take into account other data or metadata in the amalgamation, for example, numerical data such as ages, to inform the interpretation of the language elements in the text. This generates labels (16) which can define the group in the context of the other groups.

Example labels generated might be those descriptive nouns that are used most commonly in a group, compared to the word usage of all other groups. There are many tools for comparing corpora (For example Corpora using Frequency Profiling, Paul Rayson, Roger Garside, In proceedings of the workshop on Comparing Corpora 2000 or Measures for Corpus Similarity and Homogeneity, Tony Rose, Adam Kilgarriff, Proceedings of the 3rd conference on Empirical Methods in Natural Language Processing 1998).

The labels can then be used for automatic classification and categorisation of the groups of nodes.

Also generated are machine-readable signatures (17) which are unique to each group. These identify typical metrics of the data for the nodes of each group.

Where some of the nodes correspond to executable files, this might contain information about the software applications most typically associated with files in the group, and in what computer languages the files were originally implemented.

For the social network example, the signature might include the complete set of word frequencies for each group, and additional information breaking this down per individual social network user.

When data and metadata are associated with nodes, the signature might include the metadata tags used and statistics (such as the arithmetic mean and variance) calculated over the values of each node in the group.

When groups are in a hierarchy, groups at each level of the hierarchy can be analysed and labelled in context of the other groups at the same level. In this way, the labels generated can form a taxonomy.

A non-exclusive list of information that might be included in the label and/or signature is given in a subsequent section.

One use of the labels and signatures is in searching networks for relevant information. In such embodiments, searches match groups to the search terms. We describe this process more fully in a subsequent section.

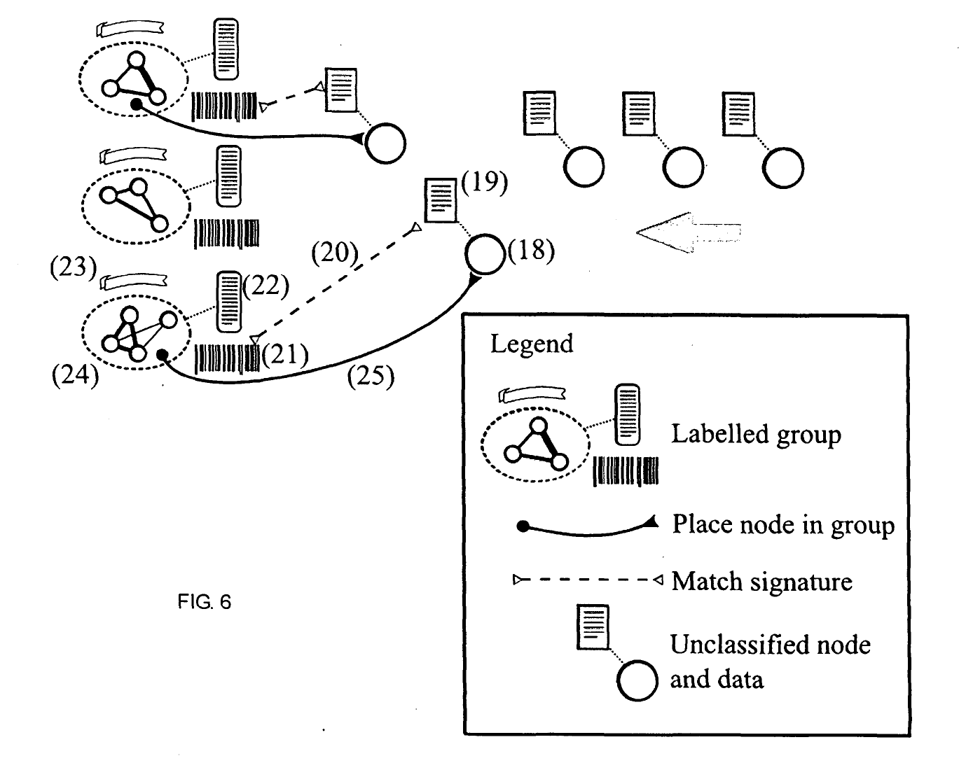

FIG. 6 is provided for use in describing step (6) of FIG. 1 (classify new data) in more detail.

The figure shows how unclassified nodes (18) and data (19) can be automatically associated with groups by identifying which existing groups are most closely similar to the new data. The data is compared with the signature (21), corpus (22) and/or labels (23) of each group and a matching group (or groups) is identified. The node can then be placed within that group (25). Any processing rules relating to that group can then be applied to the new node.

In a web server example, the classification would allow a new web page to be automatically linked into a website that had been analysed using the process described. This might involve updating the “See also” or “Suggested items” section of the new web page with links to those in the group (or groups) matched (and/or, vice versa, updating the “See also” or “Suggested items” section of the groups matched with a link to the new web page).

In a similar way, if the process had been applied to networks of blogs and/or microblogs, a new blog entry could be automatically posted to the blog sites used by the blog postings in the groups that have signatures and/or labels that most closely match the data in the new blog entry. The new blog entry can be considered to be a further node or information/data item. Information associated with the further node is used to examine the group structure of the network through the characterisations, with the further node being classified as a result into at least one existing group. At least one link is inferred between the further node (blog entry) and at least one of the nodes (e.g. blog site and/or blog posting) in the at least one group. The further node (blog entry) is incorporated or merged into at least one existing node in the network in this way.

Further applications related to classifying new information items are described in later sections.

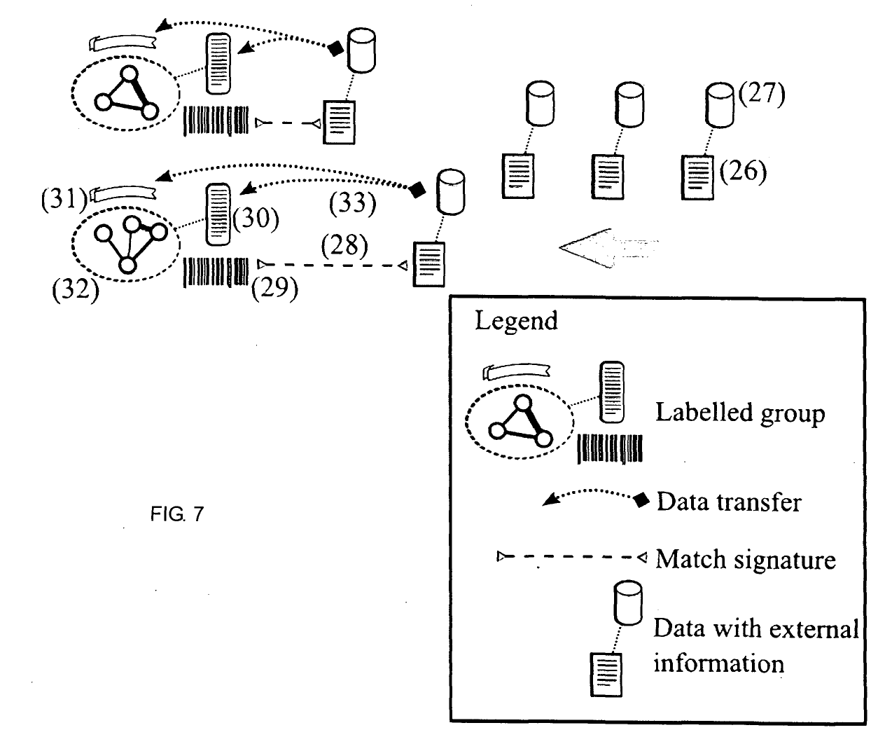

FIG. 7 is provided for use in describing step (7) of FIG. 1 (annotate labels/corpora) in more detail.

The figure shows data (26) which is associated with external information (27). The data is compared (28) with the signature (29), corpus (30) and/or labels (31) of each group and matching groups (32) are identified. The external information can then be used to annotate (33) the labels (and/or signatures and/or corpora) of the matching groups.

For example, an online survey might record a person's product preferences and ask them to identify their social network profile. The text usage from the social network profile could be matched against the labels and/or signatures of the groups, so assigning the surveyed person to one or more groups. The product preferences of that person, as identified in the survey, could then be associated with the identified groups.

In some embodiments, this might include updating the machine-readable signature of the identified groups.

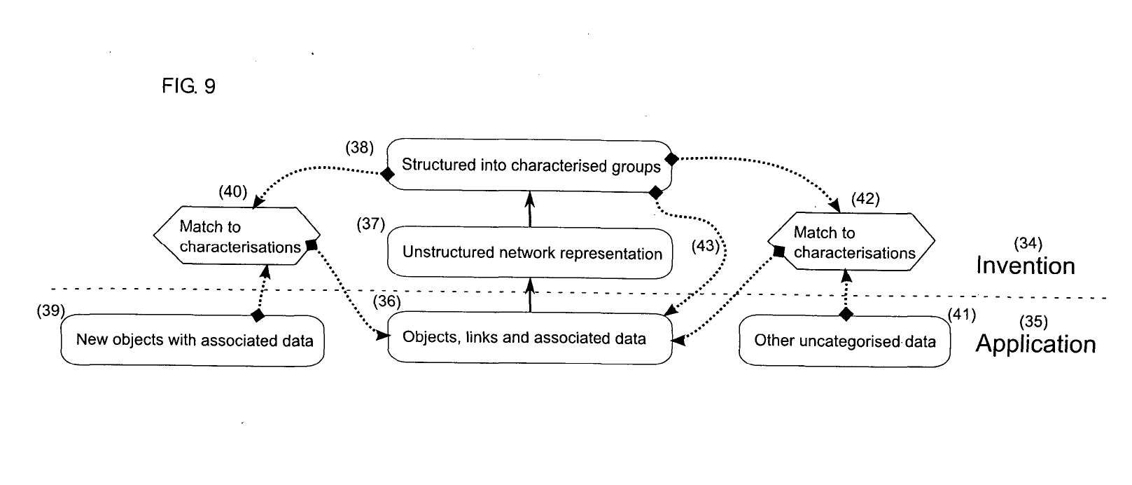

FIG. 9 is provided to summarise the nature of the invention, how it and applications based upon it relate to real world objects, and how information is processed by the invention and by such dependent applications.

The diagram shows how the invention (34) relates to applications (35) of the invention. Objects (which could be computer servers, programs/services running on computer servers, data files, or other real world objects) have information (36) about them on a computer server (or collections of computer servers). The information about the objects (36) comprises of data that identifies the objects, data from which weighted or unweighted links between the objects can be inferred, data which is associated with the nodes and any other relevant data.

An unstructured network is formed (37) from the objects, links and associated data.

The network is structured into characterised meaningful groups (38) by the invention (see FIG. 1 and other related diagrams described above).

In some embodiments, link data could be generated for new unlinked objects (39) by classifying the objects (40) using data from the characterised meaningful groups (38). This copies new objects into the Objects, links and associated data (36). This corresponds to the processes illustrated in FIG. 6.

In some embodiments, other uncategorised data (41) could be used to generate annotations for objects (42) using data from the characterised meaningful groups (38). This new data updates the associated data of the Objects, links and associated data (36). This corresponds to the processes illustrated in FIG. 7.

In some embodiments, the characterised meaningful groups of data (38) will simply be used to structure (43) the Objects, links and associated data (36) into meaningful groups. In some embodiments, this can mean that they may be processed more efficiently within the context of the characterisations of their groups.

Several example applications of the present invention will now be described. The following examples are merely intended to be illustrative of possible applications of this invention and their industrial value. This should not be taken as an exhaustive list of possible applications.

A first example application relates to optimising data storage based on predicted access patterns derived from an analysis of the links between and the content of data.

Organising data on storage devices in such a way as to optimise speed of access is a topic that has attracted considerable research and is of significant industrial value.

One of several approaches that has been successfully taken is to organise data storage and access based on an analysis of its content, for example in the field of content addressable storage (for example, “Access To Content Addressable Data Over A Network”: Carpentier et al, patent EP1049989).

The techniques disclosed here can also be used to organise the storage of and access to data items by analysing their content.

However, we take account not only of the content of data items but of links between those data items. As described earlier, the topology of the links can be used to identify meaningful groups of information items. Subsequently these are characterised to indicate the type of information stored within the group.

Similar data items, for example Web pages containing similar kinds of content, are likely to exhibit broadly similar access patterns. Web pages containing news items, for example, may be accessed more frequently than those containing rarely-updated background information, and their access patterns may also vary in a predictable way depending on the time of day.

Although it may be possible to identify relatively obvious groups such as news pages based on a web site's explicit structure, the technique disclosed here is able to identify meaningful groups of web pages based on the topology of all the identified links between pages. This makes it possible to identify groups of pages with similar content that are not readily apparent, but which are likely to exhibit similar access patterns.

Where a history of access requests has already been built up for a website, storage of and access to pages can be optimised based on extrapolating from this. However, when a website is first deployed, or when new content is added, there is no access history for the new content.

For a new website, the disclosed technique would be used to identify meaningful groups of similar pages and subsequently to use their labels and/or signatures to automatically predict likely access patterns. This can be done by comparing the labels and/or signatures of the meaningful groups in the new website with pages or meaningful groups of pages in a similar existing website for which previous access information is available.

For optimal matching, the similar existing website will have had meaningful groups identified using the technique disclosed here so that its access pattern information can be placed in the same context.

More straightforward approaches are also possible if a similar website with a recorded access history is not available. For example, if the data files are pages on a web server for which a common access method is anticipated to be via web search engines, publicly-available search keyword frequency information from a search engine provider could be matched against the labels and/or signatures of the meaningful groups of web pages. A high level of matching against common search keywords would indicate an estimate of frequent access requests.

Preferably, a combination of such techniques would be used to estimate likely file access frequency to the data file groups.

Preferably, this access frequency estimation information would be combined with any requirements to prioritise access to particular files or types of files. Groups containing such files could be marked as having a degree of increased priority.

The combination of estimated access frequency and priority information can now be used to automatically allocate data files to the most appropriate location, storage devices and access techniques.

Data files may be reallocated to new locations as necessary depending on changes to data access patterns, or to changes in other circumstances.

Where groups have high estimated frequencies and/or access priorities, their data may be automatically moved so as to ensure fast access, for example by moving the data to faster storage devices or servers, by replicating it across a number of storage devices or servers and/or by building indexes or other access optimisation mechanisms. Conversely, groups which have low estimated access and/or low priority may be moved to lower-cost lower-performance storage and/or servers.

Where new content is being added to an existing website, matching the new web page(s) against the existing meaningful groups will enable them to be automatically associated with appropriate meaningful group(s) and so with the most appropriate storage and access methods. Such matching is described more fully in the section on data classification below.

The techniques described above may also be applied to optimising the storage of and access to non-textual files, for example executable or other machine-readable files. In such cases, the links would be likely to include invocations between the files, for example as library files or web or other services. The meaningful groups would thus correspond to files that are likely to be invoked by a particular software application and the labels and signatures would draw on metadata to characterise the type of application so that it can be associated with an appropriate storage and access mechanism.

In summary this example application enables the identification of groups of files that are likely to exhibit similar access patterns because of their related content and then to use the generated labels and signatures to identify the likely type of access pattern for each group. The data in each group can then be automatically moved or configured on the network's storage devices as is most appropriate for the likely usage pattern.

A second example application relates to document classification.

In some embodiments of the invention, its value can be characterised in terms of automated document classification. This is a widely-researched area which is acknowledged to have considerable industrial value.

However, research and development is still actively being carried out to improve the accuracy of automatic document classifiers (for example: A Review of Machine Learning Algorithms for Text-Documents Classification, Baharudin et al, Journal of Advances in Information Technology, Vol 1, No 1 (2010)).

The contribution of this invention is to combine an identification of related documents (meaningful groups) based on the links between them, as illustrated in FIG. 3, with an analysis of their content and associated data/metadata, as illustrated in FIGS. 4 and 5.

The meaningful groups identified can then be processed together at some later time. The other applications in this description might form examples of later processing stages.

A further application might involve assigning unclassified or unlinked documents to labelled groups identified in FIG. 5, so that they may be processed as a part of those groups.

As one example, suppose that a document repository contains technical reports and specifications on various topics. Metadata may have been added to organise this repository and to assist in identifying reports that relate to particular topics in order to take best advantage of existing technical knowledge. The repository could be informal, or could make use of one or more software products designed to manage and organise documents and other information. As well as its roles in annotating and helping to locate, identify and interpret the documents, the metadata is likely to imply links between them. For example, it may group documents by topic, by publication date, by type of technology described and/or by other attributes.

The documents themselves may link to other documents in the repository or outside it by textual or machine-readable references, for example URLs indicating pages on the World Wide Web.

Referring to FIG. 2, such links can be seen to form the kind of network illustrated. The nodes include the documents in the repository and the associated data for each node is likely to include at least the text content of the documents. It may also include metadata, for example the document's author and the department in which the author works. For example, if the author is an electronic engineer rather than a mechanical engineer, this may have implications in terms of interpreting the topic of a document or some of the terminology used in it.

In such an application, the process illustrated in FIG. 3 might group the nodes, corresponding to documents into a number of related groups based on some or all of these links. A particular embodiment would use a suitable grouping algorithm and weighting for different types of link in an appropriate way to best identify closely-linked sets of documents that are likely to contain information about similar topics.

For example, explicit hyperlinks between documents and presence in the same index in the document repository might be weighted differently. Links to external documents such as URLs might also be weighted differently. Particular embodiments might choose to include URLs linked-to by the documents as links, on the principle that similar documents may reference similar external information, or not, or this might be an option that can be chosen.

In some embodiments it may be possible to tune the mechanism that the application uses to identify closely-linked groups, for example by requesting that it identify a larger or smaller number of groups, or by adjusting the weighting for different types of links.

In preferable embodiments of this invention, these groups will be based on significantly more information than either a database search of the repository or a search of human or machine-generated indexes, or even a combination of the two. By taking account of additional links between the documents themselves and/or from the documents to external documents, new information about the information topic structure of the repository is generated.

Once the groups have been identified, data about each group is amalgamated as in FIG. 4. At this stage, additional information may be included into the corpus based on the data or metadata. For example, if document metadata does not include the author's department or job title this may be extracted from sources outside the repository, for example a staff database, for reasons outlined above.

The corpora are now automatically compared as in FIG. 5. A very basic example of such a comparison might be to identify the most common distinguishing nouns in the amalgamated text. There are many known techniques for carrying out such a process, for example “What's In A Word-List? Investigating Word Frequency and Keyword Extraction”. Dawn Archer. (ed.). Farnham: Ashgate, 2009. In preferred embodiments, the corpora would be compared using a variety of textual and non-textual techniques and all results added to the machine-readable signature of each group. This might, for example, include specialised analysis to determine whether or not a document is likely to be a particular type, for example a scientific paper, by inspecting the format and looking for certain keywords.

The label of each group might be in a simple text format, for example containing distinguishing keywords, and could be used as an indication of the character of the group by software that had no knowledge of the structure of the machine-readable signature. The latter, however, would be likely to be a complex datastructure containing a wider variety of information distinguishing the corpus from the other corpora. If the documents were, for example, blog postings rather than reports, one of the contents of the signature might be an estimate of the sentiment expressed by the language in the corpus: is it on average more or less positive about its topic than the language in other corpora?

Having performed the labelling, the newly-generated information can be used in a variety of ways. For example, it would be possible to frame a search query that would seek to identify documents that were about innovations in digital signal processing that are likely to reduce power usage. A search tool that was unable to use information in the signature might simply match these keywords against the labels of each group and find the best matches. Preferably, an embodiment of this invention would use more sophisticated information held in the signature: for example how likely a corpus of reports was to contain guidance on technology trends and innovations, compared to the others.

Having identified the best-matching groups, the search could then be refined by searching preferentially in only those groups that are known to contain closely-related information.

A more detailed description of how such searching can be implemented in the context of this invention is given in a subsequent section.

The characterisations can also be used to classify new documents or other information by comparison with the groups. In this case either the entire text of the document or a subset of it (automatically selected to identify, for example, key nouns or verbs within it), could be compared with the labels and/or signatures of the groups to find the closest matches. The new document can then be automatically inserted into the most closely-matching groups in the repository.

In a similar example application, the repository could consist wholly or partially of web pages and, after classification, the new document or web page could be automatically linked to or from existing pages as outlined in the description of FIG. 6.

Another, related, application might compare in a similar way a technical or other document, for example a newly-written scientific paper or patent, with the labels and/or signatures of identified groups of existing documents. Such a comparison might identify hitherto-unknown related information. In the case of a scientific paper, for example, it might indicate related work, possibly in an apparently-unrelated discipline. This could be used to automatically generate additional citations for the scientific paper to acknowledge the existing work.

A third example application relates to improving automated navigation tools that provide access to related information items.

Many web sites, such as Amazon and YouTube, provide automated navigation tools that allow users of their web sites to navigate directly to related items (such as related products or videos). In these examples, when a web page is being viewed which is assigned to a particular product or video clip, a list of alternative products or video clips is automatically presented to the user. Such mechanisms providing navigation to related information items are an important part of the practical value of these web sites. The contribution of this invention is to combine an identification of related items (meaningful groups) based on the links between them with existing techniques for automatically building such navigation tools.

Data for each item could be taken from the descriptions on the web pages of the items, or (in the case of books) the text of the items themselves. Processing can be done on videos and sound files to generate characteristic data to further classify these items. Examples of such processing could include speech recognition. Text associated with any item could then be further analysed with sentiment analysis, and/or narrative analysis.

The links can be generated from the access history of users of the items, and/or heuristics based on the data/metadata of the items, as already outlined in association with FIG. 2. One example of a link could be a user accessing the web pages associated with two items within a specified time-period and/or number of navigational or other types of interactions with the system. Other users performing the same access pattern would strengthen the link. Different types of access (such as viewing a product, or buying a product) could form different types of links when the process is iterated, or strengthen links in different ways. Alternatively, or in addition, different networks of links might be generated corresponding to different types of access history. For example, where categories of user have been identified based on their demographic or purchasing histories, or other information, the access histories of specific user types could be used to generate different networks corresponding to the those user types. Different and appropriate navigation tools could then be presented to users based on their identified type, based on the associated group structuring.

Other techniques of identifying nodes and/or links could be used. These include relevant examples given in the other applications.

Groups of items are formed as illustrated in FIG. 3, with an analysis of their content and associated data/metadata, as illustrated in FIGS. 4 and 5. Items from the groups identified will then form lists of related items which can then be copied into the web pages assigned to those items to provide the user with an automated navigation mechanism to those related items.

Users of the web sites can also be characterised according to the meaningful groups of those items they have accessed. This information would then be copied to another server for further processing.

The meaningful groups identified can then be processed together at some later time. The other applications in this description might also form examples of later processing stages.

A further application might involve assigning unclassified or unlinked items to labelled groups identified in FIG. 5, so that they may be processed as a part of those groups. They could then quickly join those groups' related items pages.

A fourth example application relates to using group labels and/or signatures in the identification of relevant information.

Web search engines, such as Yahoo, have in the past grouped web pages into categories. Search results would return these categories of web pages as well as matching web pages. This system suffered from the fact that many web pages were not classified as they required human classification, or automatic classification was limited. The invention addresses this problem.

More generally, as outlined in the description of FIG. 5, one use of the labelling and signatures of the groups is in identifying relevant information in a network of information sources so that the information identified can be processed.

In embodiments where nodes correspond to web pages, an example might be a requirement to pick web pages containing information relating to certain topics. The web pages found could then be automatically copied to another computer on a network. The topics could be identified using a set of keyword(s), or by a more complex search specification, which can be considered as a further node whose place in the group structure is to be identified.

This search specification can be compared against the corpora and/or labels and/or signatures of the groups to identify the groups of web pages that most closely match the search requirements. A comparison against the corpus would identify groups in which the search term(s) match against one or more of the web pages in the group. In itself, this is very similar to existing web searching techniques, except that it identifies the group of related pages as well as potentially individual pages that match the search specification.

In this way, the further node (search query or specification) is classified into one or more of the existing groups, and at least one link between the further node (search query or specification) and at least one of the nodes in the one or more groups is inferred. Information relating to at least one of the nodes linked to the further node (search query or specification) through the at least one inferred link can then be provided, this information representing the result of the search query.

In addition, information in the label and/or signature can additionally identify those groups in which search keywords are more distinctively part of the topic of the group than in other groups.

For example, if it is required to identify web pages containing information about networks, it would be possible to simply use the keyword ‘network’ as a search term. In preferred embodiments of this invention, groups whose corpora contain this keyword will be ranked by using information in their labels and/or corpora to identify those groups in which the keyword ‘network’ particularly characterises the group corpus compared to the other groups.

Because each group is known to contain related information, it is likely that each identified matching group will preferentially contain references to the search terms in a particular context.

In this example, the web pages in individual matching groups might primarily contain discussions of computer networks, social networks, transport networks or organisations with the word ‘network’ in their name.

The process could be iterated by searching again only on the identified groups using additional search terms, or by using established web searching techniques on the identified groups to identify individual web pages within them.

This potentially greatly increases the accuracy of the search and is able to deliver higher quality information for further processing.

Also, in some embodiments, it could be possible to exclude certain groups from future searches. For the example given, groups that contained discussions about transport networks could be excluded in order to improve the accuracy of the search results.

In general, such searches will require searching the corpora of the groups, but in preferred embodiments such searches will also be guided by the labels and/or signatures of the groups. For example, these could be used to rank matching groups according to the quality of the match. A search requesting the word ‘network’ in the same sentence as the word ‘speed’, for example, could rank the matching groups depending on whether the groups' label and/or signature indicate that either or both keywords are preferentially used in the group's corpus compared to the other groups.

In this example, this might identify web pages preferentially containing information about the (data transfer) speed of computer networks, without including information about the (driving) speed on road networks.

The search specifications may be more complex than simple keyword lists and include, for example, Boolean, proximity and similarity operators to refine the search.

A fifth example application relates to identification of particular types of social media users or their discussions.

Forms of social media analysis have been in existence for many years but with the dramatic rise in the number of users and volume of traffic in social media and associated forms of user-generated content, the field has been becoming increasingly important (for example: “Machine Learning for Social Media Analytics”, P. Melville, et al., 4th Annual Machine Learning Symposium, New York Academy of Science, 2009).

A key problem in the field is in picking out relevant dialogue about the topic of interest from the very large volume of traffic. This is in some ways similar to the document repository search example outlined above, but has specific features and has a different kind of value.

Some applications of social media analysis involve identifying what is sometimes called “the Voice of the Customer” (for example: “The Voice of the Customer: Innovative and Useful Research Directions”, Stuart E. Madnick, VLDB '93, Proceedings of the 19th International Conference on Very Large Data Bases). Companies that sell products or services to consumers have always recognised significant value in understanding what kinds of existing or potential customers hold what kinds of views on their products or services. Traditionally, this information has been elicited by various forms of surveys, but such techniques are acknowledged to have a number of disadvantages, for example expense, sample size and subject bias.

More recently, however, many techniques and products have been developed that attempt to automatically extract and interpret online discussions about topics such as products and services, news events and political policies.

Although existing techniques are acknowledged to be already of practical value, they face a number of significant challenges.

For example, online discussions about a particular topic are not a single conversation, but a set of interlinked sub-conversations that involve groups of social network users who are broadly similar in their interests and in which forums they choose to discuss them. Identifying what kind of people are taking part in which of these conversations is important in understanding the meaning and relevance of their comments.

Network analysis techniques have been used to assist in identifying such groups (for example Kelly, J. & Etling, B. (2008). Mapping Iran's Online Public: Politics and Culture in the Persian Blogosphere. Research Publication No. 2008-01. Cambridge: Berkman Center for Internet and Society at Harvard University. Downloadable from http://cyber.law.harvard.edu/sites/cyber.law.harvard.edu/files/Kelly&Etling_Mapping_Irans_Online_Public_{—}2008.pdf). The process disclosed uses network analysis to form clusters of interlinked nodes that can be identified by human eye.

An embodiment of the present invention, however, adds significant value by automatically identifying meaningful groups of nodes, subsequently amalgamating data from the identified groups, as in FIG. 4, and comparing the corpora so generated to create distinguishing labels and signatures for the groups, as in FIG. 5. In the Kelly & Etling article, it is clear that an analysis of the content of the Internet resources is used to define the groupings, for example through an analysis of the frequency of words and phrases in blog posts. In other words, the content is analysed before the groupings are determined. On the contrary, with an embodiment of the present invention the groupings are largely decided before any real content analysis is performed, based largely or even entirely on links between nodes (though the links may be inferred from information relating to the linked nodes).

In a similar way to the example applications described above, the labels and signatures can be used to characterise the groups. In the social media context, for example, information derived from online surveys could be matched against the labels and signatures of the groups. The groups could then be further annotated with information derived from the associated surveys, as illustrated in FIG. 7. Such annotation might include demographic estimates derived from the surveyed users and would serve to estimate the demographic range typical of social media users in each of the groups.

Such annotation could subsequently be used in automated processing, for example to identify online conversations about certain topics being carried out by social media users with a particular demographic profile.

Such information would also be of value in automatic interpretation of the natural language exchanges within the groups. Understanding of the social group that is predominantly writing the text is helpful in automatic natural language interpretation, for example in the ability to disambiguate otherwise-ambiguous words or grammatical usage.

A sixth example application relates to optimising data service networks.

There are increasing numbers of data centres around the world. These data centres have many computers in a network that process data and transfer data. Computer services can use different types of resources, such as computer processing, memory, hard drive space and network resources and often, unpredictably, invoke other services that have different resource patterns. Being able to predict the impact of how services run on these computers will use resources such as network connections and electrical power can make data centres run more efficiently.

A method according to an embodiment of the present invention takes account of links between services on the network to build groups. This allows for resource-usage patterns to be calculated on a group-by-group basis.

Information associated with each node could include typical resource usage statistics for the service, text describing the service, and metadata tags used to transmit information

Statistical resource usage data of the different services could then be calculated from amalgamated data (see FIG. 4). A sampling process could be used at this stage to minimise the amount of data collected.

Machine-readable signatures are calculated for each group as shown in FIG. 5. These could include resource usage statistics on data such as memory usage, processor usage, time of day used, or network usage. Group level statistics could be generated by sampling processes from the different groups.

Groups of services could then be allocated to data centres with different resource capabilities, based on the group level resource usage data stats. For example, some groups will need a lot of processing power, but not much interconnectivity and could be assigned to data centres which have powerful computers that are not so interconnected.

By forming groups of services, optimisation can then be done based on the groups rather than the individual services. This can make it simpler to use optimisation algorithms, such as hill-climbing algorithms, which could then be used to assign the groups of services to the different data centres.

Other machine-readable signatures generated could include frequencies of meta-data tags used or frequencies of words used in the descriptions. New unclassified services could then be assigned to groups based on matching characteristics such as meta-data tags used.

A seventh example application relates to identifying different types of financial behaviour.

Financial transactions can take place within the context of groups of individuals or companies (corporations in the US). Identifying and characterising those groups can be useful in correlating group-level financial behaviour with external phenomena. Other uses could include predicting market movements or identifying suspicious groups. The group summary data or labels could then be transferred to a server so that the groups may be processed further by some other application.

A network is formed with nodes representing individual people, or companies (corporations in the US). Data associated with nodes could be text from web pages, financial data or any other relevant data. Links could be inferred between nodes by financial transactions (such as the transfer of money from one node to another), or similar financial behaviour (such as correlated stock movements).

Groups are then formed as illustrated in FIG. 3, the data is amalgamated as illustrated in FIG. 4, and summary data is generated for each group as illustrated in FIG. 5. The summary data, both labels, signatures and corpora, is transferred to a server for further processing.

This approach is different to other approaches (Somaraki et al 2007; Bech, Chapman and Garrat 2008; and Embree and Roberts 2009) which identify topological features in company networks as it identifies groups in the networks.

Following the above description of several illustrative applications of the present invention, further discussion will now be provided concerning example contents of the group labels and signatures.

As illustrated in FIG. 5, one of the above-described steps according to an embodiment of the present invention is the annotation of the groups generated as in FIG. 3 with machine-readable signatures and labels. Both labels and signatures contain information about their associated groups, while labels contain information about how each group differs from the other identified groups.

A signature is generated from the corpus of information of a group. It acts as a statistical measure of the features of a corpus. Signatures are usually generated using the same method for each corpus, or for other data outside the existing groups.

It is then possible to measure the difference between two corpora (or between a corpus and some other data) by comparing (perhaps mathematically) the two signatures. This means that other corpora, or other data in a similar format (for which a signature can be generated), can be quickly compared to each corpus by comparing the two signatures.

A label is also generated from the corpus of information of a group in context of the other corpora. Labels are composed of data extracted from each corpus. The data extracted from each corpus are those that are shown, often using statistical techniques, to be significantly different from (either all, or some of) the other corpora. As such, the labels constitute some (or all) of those features that are unique to each corpora, within context of the other corpora.

For a simple example, where the group corpora contain textual data, the signatures could simply just contain the frequencies of each word per information source (or per node). When nodes are associated with numerical data, statistical information about the distribution of the data could be used.

Signatures can, for example, be assessed against each other by taking the average of the difference between the word frequencies used in the signature. When there is other data in the signatures, such as numerical data, the difference between two distributions (perhaps using a Students t-test) can be used to assess two signatures.

In the same example, a label would contain a list of key words, phrases or other language components that are significantly (statistically speaking) more common in the group than in other groups. This could be calculated for each word in each group by comparing the frequency of word usage per information source in the group with the frequency of word usage per information source in the whole information network using, for example, a Z-test. The Z-value computed would then rank the words in order of how more commonly (for high values), or less commonly (for low values) they are used than average. Alternative techniques are also known, for example Paul Rayson and Roger Garside. 2000. “Comparing corpora using frequency profiling”. In Proceedings of the workshop on Comparing corpora—Volume 9, Vol. 9. Association for Computational Linguistics, Morristown, N.J., USA, 1-6.

Alternatively, labels can be generated for a group by first identifying the group with the closest signature. This could be done by assessing the signature (as outlined above) of every group being labelled against every other. Then labels are those words that are statistically more common in the group being labelled than the group with the closest signature. Again, this could be calculated for each word in each group by comparing the frequency of word usage per information source in the group being labelled with the frequency of word usage per information source in the group with the closest signature using, for example, a Z-test or a students t-test.

Other corpus comparison techniques may be used to generate labels or signatures and assess signatures against one another. Some example techniques are described in P. Drouin. “Detection of domain specific terminology using corpora comparison” in Proceedings of the fourth international Conference on Language Resources and Evaluation (LREC), Lisbon, Portugal, 2004.

Any mathematical technique that approximates or calculates the significance (or just measures the extent) of different word usages could be used to assess the difference between signatures and labels, or generate the signatures or labels. Other techniques that may be used include Bayesian analysis or bootstrapping.

In preferable embodiments of this invention, a range of more complex analytical information would also be available, depending on the particular application.

In preferable embodiments, information items to be compared against the meaningful groups will be processed using identical or similar techniques to those used to generate the labels and/or signatures of the groups.

For example, suppose that a web page is to be compared against identified meaningful groups of web pages whose labels and/or signatures contain information about distinctive keywords within the group corpora. This might be done in order to identify a group into which the new web page will be automatically linked. Ideally, the new web page would be processed using the same algorithms used to generate the distinctive keywords in the group labels and/or signatures, for maximum comparability. Where, as typically will be the case, the algorithms will have compared each groups' corpus against the corpora of the other groups to identify its distinctive keywords, preferably the corpus formed by amalgamating the significant groups would be used to identify the distinctive keywords of the new web page.

Where it is not possible to use similar techniques to those used to characterise the groups, however, more straightforward comparisons can still be used. For example, simple keyword matching of a new web page against the labels of the identified groups. The accuracy of matching will be reduced, but will still serve to usefully classify new information against matching meaningful groups.

A non-exhaustive list of possible information to be contained in the signatures and/or labels now follows, for illustrative purposes. In each case the information may include a statistical distribution of the particular attributes within nodes in the group or in comparison with the corpora of the other groups:
Information about the distributions of values of the data associated with the nodes and other physical information such as where and how information associated with the nodes has been stored and updated
Distinguishing keywords, phrases or linguistic components, potentially for use in search and/or classification
Distinctive metadata associated with the node, for example publication dates, authorship and modification information, information about how, when and by which user or automated process the nodes in the network were accessed
Information about the frequencies of use (and other statistical measures) of the metadata associated with each node
The result of specialised analyses carried out on the node's corpus, including but not limited to an estimate of the sentiment expressed in language associated with the group corpus, estimates of whether nodes in the corpus correspond to certain specialised information types (for example a component file of Microsoft Office, a technical report, part of a financial loan transaction).

It is to be understood that FIG. 1 can be considered both to illustrate steps in a method embodying the present invention, and components of an apparatus according to an embodiment of the present invention. When viewed as an illustration of the steps performed in an embodiment of the present invention, the text in the figure can be considered a summary of the step performed. When viewed as an illustration of the components of an apparatus embodying the present invention, the text in the figure can be considered a summary of the function of each component.

It will be appreciated that a method and apparatus according to an embodiment of the present invention can be implemented in the form of one or more processors or processing units, which processing unit or units could be controlled or provided at least in part by a program operating on the device or apparatus. The function of several components illustrated in the drawings may in fact be performed by a single component. A single processor or processing unit may be arranged to perform the function of multiple components. Such an operating program can be stored on a computer-readable medium, or could, for example, be embodied in a signal such as a downloadable data signal provided from an Internet website. The appended claims are to be interpreted as covering an operating program by itself, or as a record on a carrier, or as a signal, or in any other form.

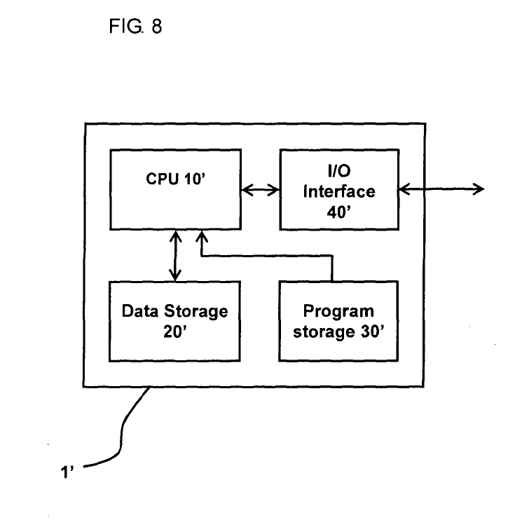

For example, FIG. 8 is a schematic illustration of a computer apparatus 1′ in which a method embodying the present invention may be implemented. A computer program for controlling the computer apparatus 1′ to carry out a method embodying the present invention is stored in a program storage 30′. Data used during the performance of a method embodying the present invention is stored in a data storage 20′. During performance of a method embodying the present invention, program steps are fetched from the program storage 30′ and executed by a Central Processing Unit (CPU) 10′, retrieving data as required from the data storage 20′. Output information resulting from performance of a method embodying the present invention can be stored back in the data storage 20′, or sent to an Input/Output (I/O) interface 40′, which may comprise a transmitter for transmitting data to other nodes, as required. Likewise, the Input/Output (I/O) interface 40′ may comprise a receiver for receiving data from other nodes, for example for use by the CPU 10′.

It will be appreciated by the person of skill in the art that various modifications may be made to the above described embodiments without departing from the scope of the present invention.

1.-48. (canceled)

49. A method of structuring a network of nodes, comprising:
providing link information relating to existing or implied links between the nodes;
using the link information to partition the network into non-predetermined groups of related nodes, thereby forming a group structure for the network;
identifying for each group a corpus of information associated with the nodes in that group, the corpus of information being distinct from the group structure;
generating for each group a machine-readable characterisation of that group based on the corpus of information identified for at least the group; and
structuring the network of nodes through the groups and their associated characterisations.

50. The method of claim 49, wherein the link information comprises a weighting for each of at least some of the links, the weighting being an indication of the degree of similarity between linked nodes.

51. The method of claim 49, wherein at least one of the nodes is or comprises a computer server.

52. The method of claim 49, wherein at least one of the nodes is or comprises a data item.

53. The method of claim 49, wherein at least one of the nodes comprises a document, a machine-readable file such as a data file or an executable file, or a plurality of machine-readable characters such as a search term.

54. The method of claim 49, wherein at least one of the nodes comprises a web page and/or blog, or element thereof such as an article or blog posting.

55. The method of claim 49, wherein at least one of the nodes represents an individual.

56. The method of claim 49, wherein at least one of the nodes represents a service run on or provided by a computer server.

57. The method of claim 49, wherein a link between two nodes is an indication of some degree of similarity between the two nodes, actual or perceived, with the degree of similarity having been assessed manually or automatically.

58. The method of claim 49, wherein a link between two nodes is an indication of a relationship or connection or interaction or transaction or correlated behaviour between the two nodes, past or present.

59. The method of claim 49, wherein at least one link between two nodes is a logical link between the two nodes.

60. The method of claim 49, wherein at least one link is derived or inferred from information relating to the two nodes.

61. The method of claim 60, wherein the providing step comprises deriving or inferring at least one link.

62. The method of claim 49, wherein at least one link between two nodes is or represents a physical connection between the two nodes.

63. The method of claim 49, wherein at least one link between two nodes is in the form of a hyperlink such as a URL.

64. The method of claim 49, wherein the partitioning step comprises assigning each node to at least one group of nodes where groups are defined by their topological characteristics, relating to the number and/or weights of the links within the group with respect to the rest of the network.

65. The method of claim 49, wherein the links are weighted and the partitioning step comprises assigning each node to at least one group of nodes so as to approach a maximum proportion of the combined weights of links that are between nodes of the same group, when compared with the proportion of links that are between nodes of the same group when all links are randomly rewired.

66. The method of claim 49, wherein the partitioning step comprises assigning each node to at least one group of nodes.

67. The method of claim 49, wherein at least one group of nodes comprises within it at least one other group of nodes.

68. The method of claim 49, wherein the partitioning carried out in the partitioning step is based entirely on links between the nodes.

69. The method of claim 49, wherein at least one node is assigned to more than one group of nodes.

70. The method of claim 49, comprising, for at least one of the nodes, including metadata associated with that node information in the corpus of information for that node.

71. The method of claim 49, comprising, for at least one of the nodes, including information from sources external to that node in the corpus of information for that node.

72. The method of claim 49, wherein the characterisation comprises a signature, the signature for a group being generated based on the corpus of information for that group.

73. The method of claim 49, wherein the characterisation comprises at least one label, the label for a group being generated based on a comparison between the corpus of information for that group, or information derived therefrom, and the corpus of information for at least one other group, or information derived therefrom.

74. The method of claim 49, wherein the machine-readable characterisation for at least one group is the corpus of information for the group.

75. The method of claim 49, further comprising:
receiving a query including a search term;
comparing the search term with the corpora of information for the groups and/or with the machine-readable characterisation of the groups; and
identifying a group based on the comparison.

76. The method of claim 75, further comprising:
returning information from the identified group in response to the query.

77. The method of claim 49, wherein the structuring step comprises enabling the group structure to be examined through the generated characterisations to allow new links into the network to be created or inferred, and/or to allow existing links to be updated.

78. The method of claim 49, wherein the structuring step comprises examining the group structure of the network using the characterisations to create or infer new links into the network, and/or to update existing links.

79. The method of claim 49, wherein the structuring step comprises receiving or providing a further node not already placed within the network, using information associated with the further node to examine the group structure of the network through the characterisations, classifying the further node as a result into at least one existing group, and at least inferring at least one link between the further node and at least one of the nodes in the at least one group.

80. The method of claim 79, further comprising:
incorporating the further node into the network within the at least one group.

81. The method of claim 80, further comprising:
creating at least one link between the further node and an existing node in the network and/or incorporating or merging the further node into at least one existing node in the network.

82. The method of claim 79, further comprising:
providing information relating to at least one of the nodes linked to the further node through the at least one inferred link.

83. The method of claim 49, further comprising:
updating the corpus of information of a group and/or updating the machine-readable characterisation of a group based on external information.

84. The method of claim 49, wherein the method is a computer-implemented method.

85. An apparatus for structuring a network of nodes, comprising:
a processor arranged to provide link information relating to existing or implied links between the nodes;
a processor arranged to use the link information to partition the network into non-predetermined groups of related nodes, thereby forming a group structure for the network;
a processor arranged to identify for each group a corpus of information associated with the nodes in that group, the corpus of information being distinct from the group structure;
a processor arranged to generate for each group a machine-readable characterisation of that group based on the corpus of information identified for at least the group; and
a processor arranged to structure the network of nodes through the groups and their associated characterisations.

86. A program for controlling an apparatus to perform a method as defined in claim 49, optionally being carried on a carrier medium such as a storage medium or a transmission medium.

87. A storage medium containing the program as defined in claim 86.
